(19) United States
(12) Patent Application Publication
(10) Pub. No.: US 2006/0204620 A1
(43) Pub. Date: Sep. 14, 2006

(54) Coffee fermentation kit and method

(75) Inventors: Charles Jackels, Seattle, WA (US); Susan Jackels, Seattle, WA (US)

Correspondence Address: MILLER NASH LLP, 4400 TWO UNION SQUARE, 601 UNION STREET, SEATTLE, WA, 98101-2352, US

(73) Assignee: Seattle University

(21) Appl. No.: 11/079,326

(22) Filed: Mar. 14, 2005

(51) Int. Cl. A23B 7/148

(52) U.S. Cl. 426/106

(57) ABSTRACT

The present invention relates to a method and kit for testing the fermentation rate, fermentation byproducts and fermentation completion of coffee mucilage. The method comprises testing the fermentation rate of coffee by testing a sample of coffee suspended in water using at least one member of a group of disclosed substrates and test kits and, upon color formation, comparing the resulting color to a color scale to indirectly determine the fermentation rate, fermentation byproducts and fermentation completion. The corresponding kit comprises at least one of a pH testing strip, at least one ethanol testing strip, at least one lactic acid testing strip, and a thermometer.

### BACKGROUND OF INVENTION

1. Field of Invention

This invention relates generally to the testing and assessment of coffee, and more particularly to the testing and assessment of the fermentation rate, fermentation byproducts and fermentation completion of coffee mucilage.

2. Background

According to statistics compiled by The National Coffee Association and The Specialty Coffee Association, an estimated fifty-two percent (52%) of Americans over eighteen (18) years of age drink coffee on a daily basis. The significant number of coffee drinkers makes the coffee industry a lucrative one, with the coffee company Starbucks Corporation reporting a consolidated net revenue of $649 million for a five-week period ending Jan. 2, 2005.

However, even with the number of daily coffee drinkers and significant coffee company revenues, global oversupply of coffee has contributed to the significant drop in the world-market price of coffee. Factors contributing to the oversupply of coffee include increased coffee production, falling coffee demand, and an abundance of low-quality coffee Coffee prices have fallen so low that millions of coffee producers in developing countries are being crushed by unfair competition and cannot survive. While various organizations have implemented monitoring and certification programs to ensure that coffee producers are fairly compensated, these organizations typically rely on the conscience of the consumer. These certification and monitoring programs do not provide practical solutions for improving the actual quality of the coffee through improvement of coffee processing.

Coffee processing occurs after coffee cherries have been collected from coffee trees such as Coffea arabica or Coffea canephora. Exemplary coffee cherry collection processes include selective picking, stripping, and mechanical harvesting. After collection, the coffee process is commenced by separating the coffee cherries so that overripe and undeveloped cherries are removed from the coffee cherry collection. The coffee cherry collection is then pulped. The purpose of the pulping process is to separate the skin and fruit from the coffee cherry. Pulping may occur through a natural process, whereby the cherries are dried for days in the sun before pulping, or the coffee cherries may be pulped in a pulping machine.

After pulping, the coffee retains a mucilage layer that is quite slippery, thereby allowing the coffee to readily slide over itself. Commonly, the coffee is put through a fermentation process, wherein the slippery mucilage layer is removed from the coffee before the drying process.

The fermentation process typically includes putting the collection of coffee into a vat or other vessel for an undetermined amount of time. Water may or may not be added to the vessel and, typically, the vat includes a drain to remove liquids produced during fermentation. The fermentation process is considered complete when the coffee is no longer slippery, and the mucilage layer is loosened and can be completely washed off the coffee. Currently, in order to determine when the fermentation process is complete, a coffee producer subjectively estimates the completion time. To confirm this estimate, coffee producers typically insert and remove a long object into the vessel of coffee beans. The long object may be an arm, a tool handle or a stick, and the long object is inserted and removed into the coffee.

If the coffee has not yet completed the fermentation process, mucilage-covered coffee beans will readily slide past each other and fill in the hole created by the long object. However, if the fermentation process is complete, the mucilage layer of the coffee is no longer slippery and the coffee experiences friction sufficient to maintain the hole formed by the long object for approximately one-minute or longer. When the hole is maintained for an approximately one-minute time period, the fermentation process is said to be “complete” and the coffee is subsequently removed from the vessel and washed.

Because the determination of completion of the fermentation process is typically a subjective one, it is common for coffee producers to inaccurately estimate the completion time of the fermentation process. This leads to over- and under-fermented coffee. If the coffee is washed before the fermentation process is complete, the mucilage layer of the coffee will be incompletely removed. Incomplete removal of the mucilage layer typically results in coffee that may experience mold growth and a “clumping” together during drying. Further, the traces of remaining mucilage layer on the coffee promote spoilage of the coffee. If fermentation is carried beyond the necessary fermentation time, the coffee will wash properly. However, studies indicate that over-fermentation results in degradation of coffee quality due to the presence of undesirable fermentation byproducts. Over-fermentation of coffee is associated with taste defects in roasted coffee such as alcoholic, fruity, flowery and sour tastes and is one of the most often cited problems affecting coffee quality.

Without a method or kit geared towards assessing the rate of fermentation, understanding fermentation byproducts and providing guidance as to when the fermentation process is complete, coffee producers are left to rely on unreliable and subjective fermentation rate and fermentation completion testing methods. This leaves the coffee producer with no real understanding of the fermentation process, which, in turn, leads to the consistent production of poorly fermented coffee and an inability of the coffee producers to provide high-quality coffee to the industry.

There are some products and processes addressing various components of preparing coffee products. U.S. Pat. No. 4,867,992, entitled Natural Coffee Flavor by Fermentation, addresses producing a natural buttery flavor, winey flavor or combination buttery and winey flavor from a coffee substrate. The process involves forming a nutrient media containing water and soluble coffee solids as the nutrient component, the soluble solids concentration being at least 0.5%. A microorganism which is either a strain of lactic acid producing bacteria or yeast capable of producing diacetyl is added the nutrient media and the combination is mixed and simultaneously placed into an environment of a pH from 4.0 to 7.0, a temperature from 16° to 37° C., for a period of time effective to produce diacetyl and aeration conditions wherein the nutrient media contains sufficient oxygen to allow for diacetyl production. The aforementioned process will produce diacetyl and acetoin. The diacetyl which is produced is recovered and/or concentrated and added to a coffee product.

U.S. Pat. No. 5,147,666, entitled Removal of Malic Acid from Coffee by Fermentation, whereby malic acid is removed from coffee to provide a coffee product which will evoke a decreased gastric acid response after ingestion. Malic acid is removed by malo-lactic fermentation of an aqueous coffee extract, which may be a green or brown extract. A malic acid-lean extract can be used to extract malic acid from coffee solids to produce demalated coffee solids. Demalation is preferably accomplished without removing excessive amounts of chlorogenic acid. Coffee products in accordance with the invention are preferably decaffeinated.

### BRIEF SUMMARY OF THE INVENTION

The subject invention includes a kit and method used to test and assess the fermentation rate, fermentation byproducts and fermentation completion of coffee mucilage. Optimally, the method and kit remove the subjective aspects from the fermentation process, thereby allowing coffee producers to consistently produce high-quality coffee. Consistent production of properly fermented coffee will aid in the marketing of distinctive organic coffee from small farms.

In general, the present invention relates to a method and kit for testing the fermentation rate, fermentation byproducts and fermentation completion of coffee mucilage. The method comprises testing and assessing the fermentation rate, fermentation byproducts and the fermentation completion of coffee by testing a sample of coffee taken from a fermenting mass of coffee, mixing it with water to form a coffee sample, testing and assessing the coffee sample using at least one member of a group of disclosed substrates and test kits, and, comparing the test results to an analysis chart to indirectly determine the fermentation rate, fermentation byproducts and fermentation completion of the coffee sample. The corresponding kit preferably comprises at least one pH testing strip, at least one ethanol test strip, at least one lactic acid strip, and a thermometer. Optional kit elements include at least one glucose strip, a spoon for obtaining a coffee sample, vessels with measure lines for the coffee sample, an analysis chart, pipets, a watch, a clipboard with data sheets, a pen and a poster of visual and written instructions for use of the kit.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A and 1B are printouts of a poster of visual and written instructions for using the kit of the present invention to create a coffee sample and test the pH of the coffee sample.

FIG. 2 is a graph showing an exemplary pH range of a batch of coffee during fermentation.

FIG. 3 is a graph showing exemplary pH ranges of seven batches of coffee during fermentation.

FIG. 4 is a graph showing exemplary lactic acid ranges of seven batches of coffee during fermentation.

FIG. 5 is a graph showing exemplary ethanol ranges of seven batches of coffee during fermentation.

FIG. 6 is a graph showing exemplary glucose ranges of seven batches of coffee during fermentation.

FIG. 7 is a graph showing exemplary temperature ranges of seven batches of coffee during fermentation.

FIG. 8 is a graph showing exemplary temperature ranges of seven batches of coffee, during fermentation, relative to air temperature.

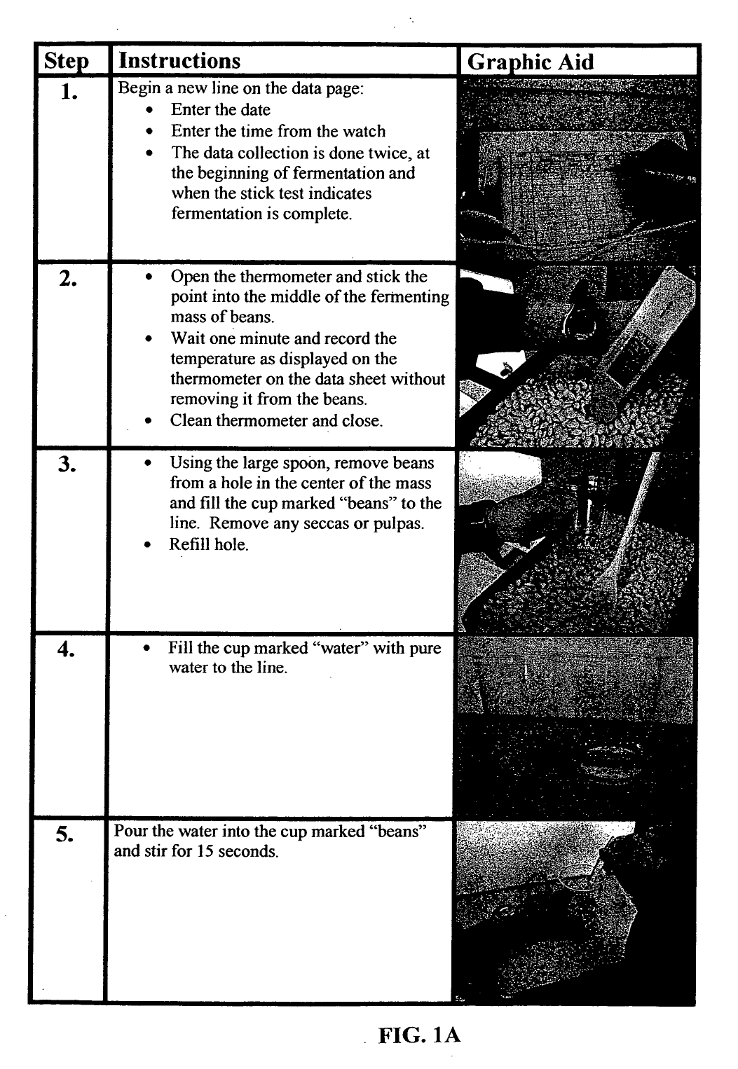

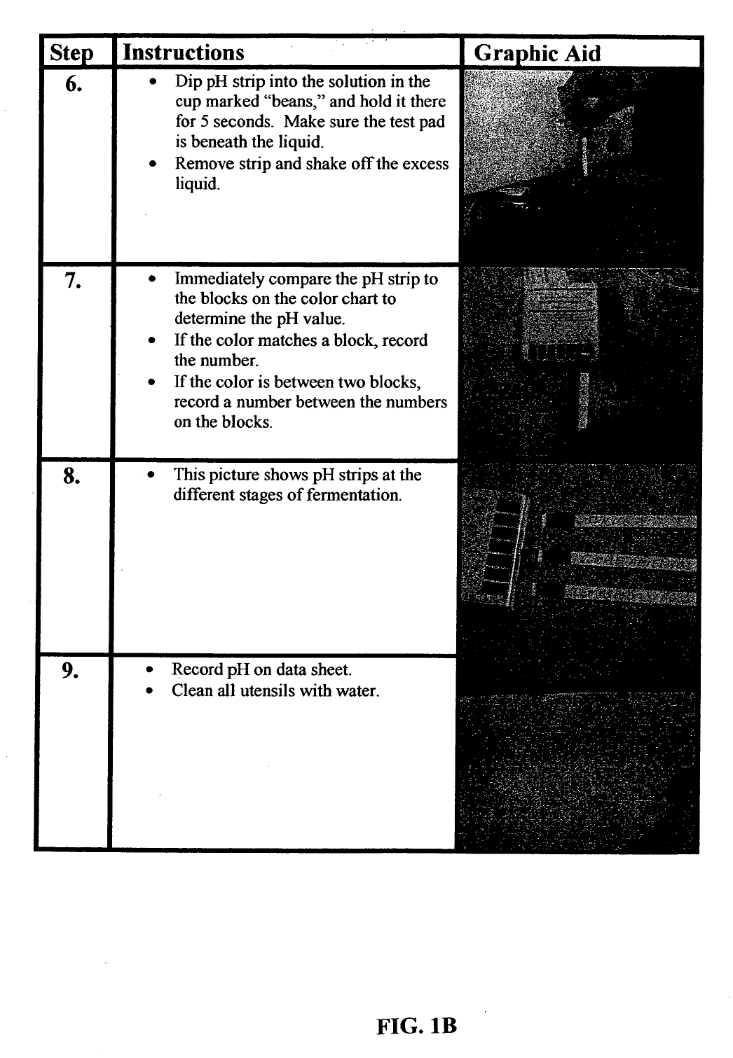

### DETAILED DESCRIPTION OF THE INVENTION

The present invention relates to a method for testing the fermentation rate, fermentation byproducts and fermentation completion of coffee mucilage and a kit associated therewith. Specifically, the kit preferably includes at least one pH test strip, at least one ethanol test strip, at least one lactic acid test strip, and a thermometer, and optionally, at least one glucose test strip, a spoon for obtaining a coffee sample, vessels with measure lines for the coffee sample, an analysis chart, pipets, a watch, a clipboard with data sheets, a pen and a poster of visual and written instructions for use of the kit. Each component of the kit recognizes some component of the fermentation process. The method and kit assist in the testing and assessment of the fermentation rate, fermentation byproducts and fermentation completion of pulped coffee.

Fermentation conditions vary significantly based on the location of the coffee farm, the fermenting batch of coffee, and the time of day during which fermentation occurs. The present invention seeks to provide a fermentation kit and method of use that can provide reliable indicators of the fermentation rate, fermentation byproducts and fermentation completion of a batch of coffee, under a variety of fermentation conditions.

Although the description generally describes a method and kit for testing the fermentation rate of coffee, it is to be understood that the present invention describes a kit and method that may be used in a variety of fermentation processes. The terms “coffee” or “coffee mucilage” as used in the description of the invention are for descriptive purposes only and are not intended to limit the scope of the invention.

Kit and Method

Kit

The preferred embodiment of the test kit of the present invention includes at least one pH test strip, at least one ethanol test strip, at least one lactic acid test strip, and a thermometer. Optional kit elements include at least one glucose test strip, a spoon for obtaining a sample, vessels with measure lines for sample and water, an analysis chart such as a color analysis chart, pipets, a watch, a clip board with data sheets for recording date, time, pH and comments, a pen and a poster of visual and written instructions for use of the kit.

The pH rate of a fermenting batch of coffee allows a coffee farmer to gauge the fermentation rate, as well as an estimate of the completion time of a fermenting batch of coffee. The at least one pH test strip reacts with an aqueous suspension of a fermenting batch of coffee and provide a simple and inexpensive method for determining the acidity of a fermenting batch of coffee. The acidity level of a fermenting batch of coffee is a reliable gauge for testing and assessing the progress of and the approximate completion time of the fermentation process.

The at least one pH test strip used in connection with the present invention may be any pH strip commonly known, but is preferably a pH strip which provides pH measurements in the range of pH 2.5 to 7. A preferred example of pH test strips are those offered by EM Science colorpHast strips offered by EMD Chemicals Inc. of Gibbstown, N.J.

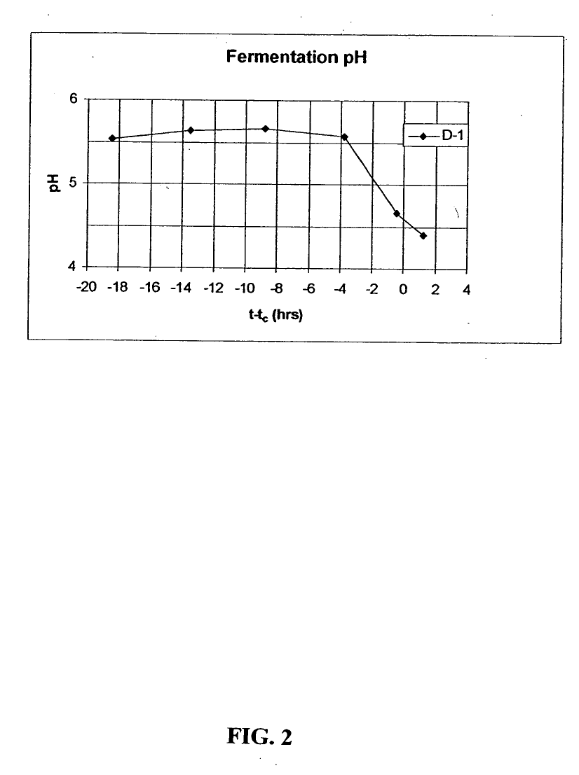

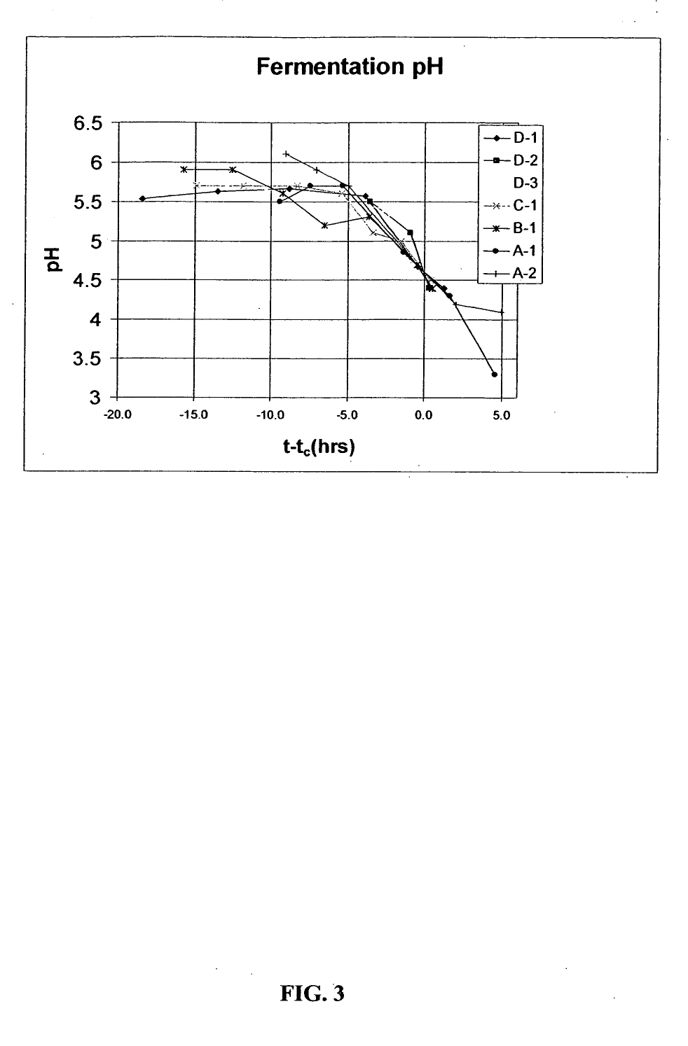

Regardless of the length of fermentation, or the starting pH rate of a fermenting batch of coffee, the pH of a fermenting batch of coffee changes significantly during the fermentation process and can be used to ascertain completion of the fermentation process. At the start of fermentation, and during the majority of the fermentation process, the pH level of the fermenting batch of coffee beans remains consistent. This is because the coffee beans have not fermented for a time sufficient to produce acid nor to separate the mucilage from the parchment. However, as a fermenting batch of coffee nears completion, the acidity level of the batch of coffee decreases significantly and rapidly. The sharp decrease in the pH level of the batch of coffee may be viewed in FIGS. 2 and 3. This is a result of the batch of coffee producing large amounts of acid. Testing the pH of a fermenting batch of coffee is thus an informative way to determine the progress of fermentation, as well as the approximate completion time of the fermenting batch of coffee.

A pH value of approximately pH 5.0 indicates that the fermenting batch of coffee is under-fermented, and that fermentation should likely be completed within approximately two hours from the time the pH test is conducted. A pH value of pH 4.0 or below indicates that fermentation is past completion and the batch of coffee is likely over-fermented. A pH value between 4.1 and 4.9 indicates fermentation completion, and a value of pH 4.6 is the preferred completion pH value for a fermenting batch of coffee.

FIGS. 2 and 3 show graphs detailing the pH ranges of batches of coffee during the fermentation process. In FIG. 2, at approximately 14 hours, the pH range of the fermenting batch of coffee is relatively consistent, between pH 5.5 and 5.7. However, between −4(t-t_{c}) to ˜+1(t-t_{c}), the pH range of the fermenting batch of coffee decreased from approximately pH 5.5 to approximately pH 4.4. As the preferable pH measurement of a completed batch of fermented coffee is ˜pH 4.6, the coffee farmer could determine, from assessing the pH measurement of the fermenting coffee, that the exemplary batch of fermenting coffee reached preferably fermentation completion between ˜−1(t-t_{c}) to ˜+1.5(t-t_{c}).

At least one ethanol test strip is also included with the kit of the present invention. An ethanol test strip is used to test the level of fermentation byproducts, such as yeast, of a fermenting. Because byproducts, such as yeast, greatly affect the taste and quality of coffee, and because yeast produces ethanol, the ethanol test strips provide coffee producers with an efficient way to control the quality of coffee.

The ethanol test strips also provide a way for a coffee farmer to assess the approximate completion time of a fermenting batch of coffee. Specifically, because yeast thrives at lower pH values, towards the completion of the fermentation process, the pH level of a fermenting batch of coffee will decrease significantly and rapidly. Thus, by measuring the ethanol content of a fermenting batch of coffee, a coffee producer is also able to test and assess the fermentation rate of a fermenting batch of coffee.

The type of ethanol test strips used in connection with the present invention may be any ethanol test strips commonly known and used in the industry.

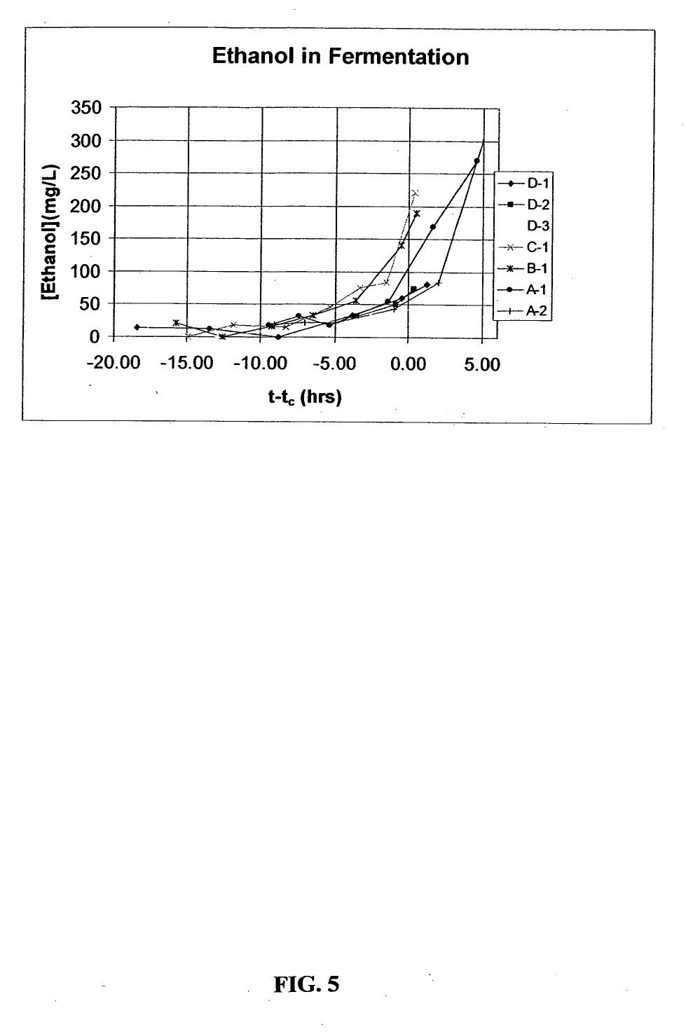

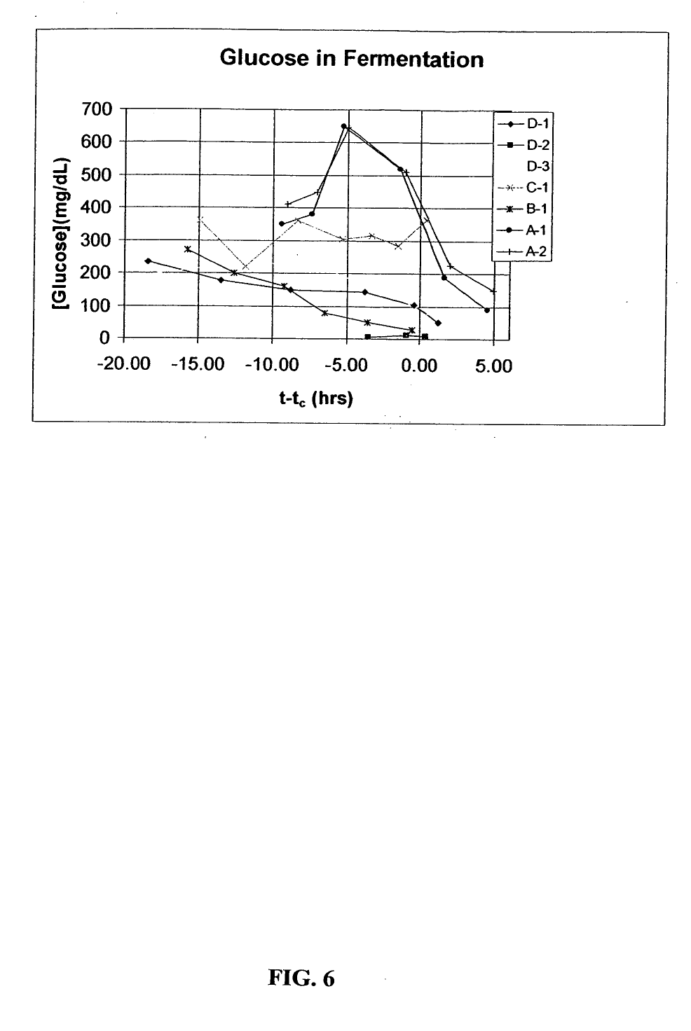

FIG. 5 shows exemplary ethanol measurements for seven different batches of coffee during the fermentation process. As is evident from FIG. 5, the ethanol concentration in the seven fermenting batches of coffee remained generally consistent throughout the fermentation process. However, towards the end of fermentation, the ethanol concentration of the fermenting batch of coffee dramatically increased. As stated previously, this increase in the ethanol concentration was due to the higher levels of yeast in the fermenting batches of coffee.

By testing and assessing the concentration of ethanol in a fermenting batch of coffee, the coffee producer may either stop the fermentation process to prevent off-flavor fermentation byproducts or change the variables in the fermentation process by adding or removing liquid to the fermentation batch. The ethanol concentration also allows a coffee producer to determine the amount of time that a batch of coffee may sit after fermentation before being washed. Although ethanol is preferably washed off the coffee after the fermentation process, it sometimes dissolves into the coffee bean itself, which often results in an undesirable coffee flavor. Testing of the ethanol levels of a fermenting batch of coffee emphasizes the importance of determining the end of fermentation and immediately beginning the washing step.

At least one lactic acid test strip is also provided in connection with the kit and method of the present invention. The lactic acid test strips may be any commonly used lactic acid strips known and used in the industry.

Lactic acid is generated as a byproduct of the growth of certain bacteria during fermentation. Thus, the at least one lactic acid test strip provides another mechanism by which the coffee farmer can assess the concentration levels of fermentation byproducts in a fermenting batch of coffee.

Further, in combination with other acids that may also be generated during the fermentation process, lactic acid is responsible for the drop in pH as fermentation progresses. Thus, measuring the lactic acid concentration of a fermenting batch of coffee allows a coffee farmer to evaluate how the lactic acid concentration may affect the pH, and in turn, the fermentation completion time of a fermenting batch of coffee.

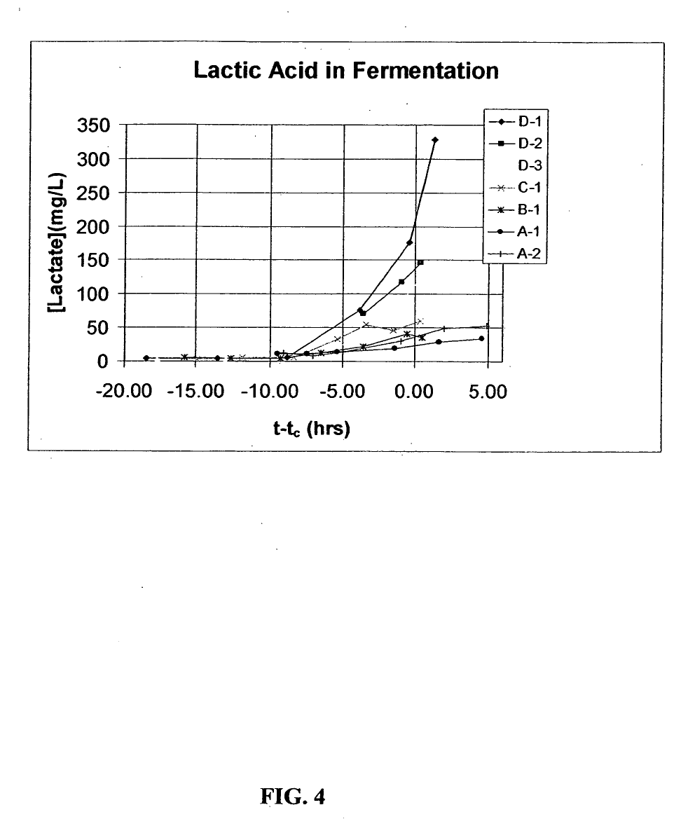

FIG. 4 shows lactic acid measurements for seven different batches of coffee during fermentation. The lactic acid concentration in each of the fermenting batches of coffee remained consistent throughout most of the fermentation process. However, towards the end of fermentation, the lactic acid concentration of each fermenting batch of coffee increased. This increase signaled the growth of byproducts in the fermenting coffee.

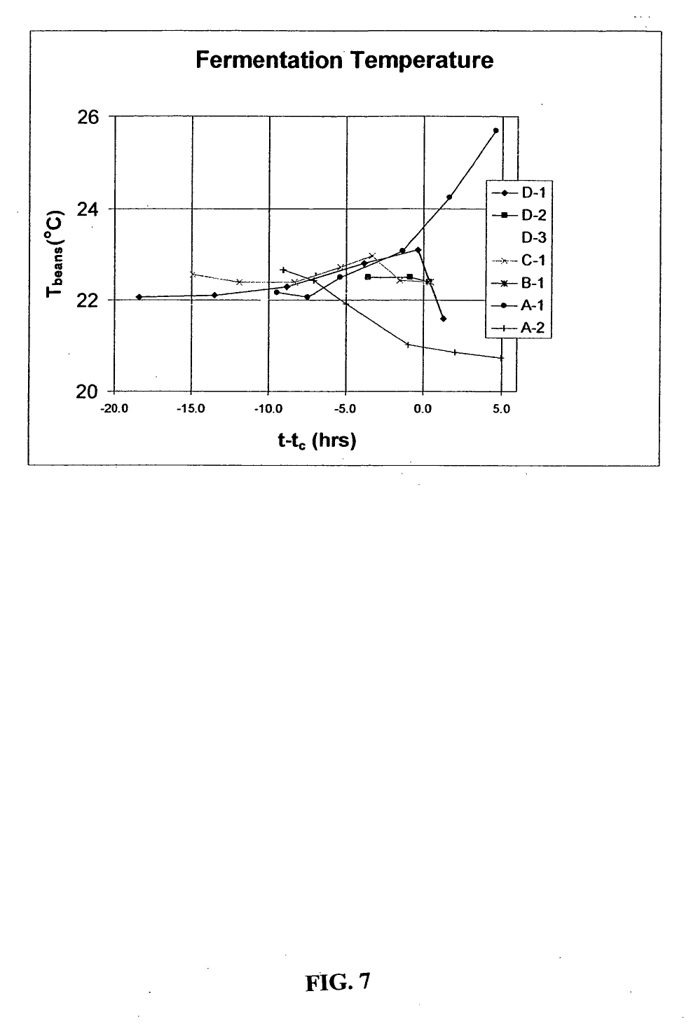

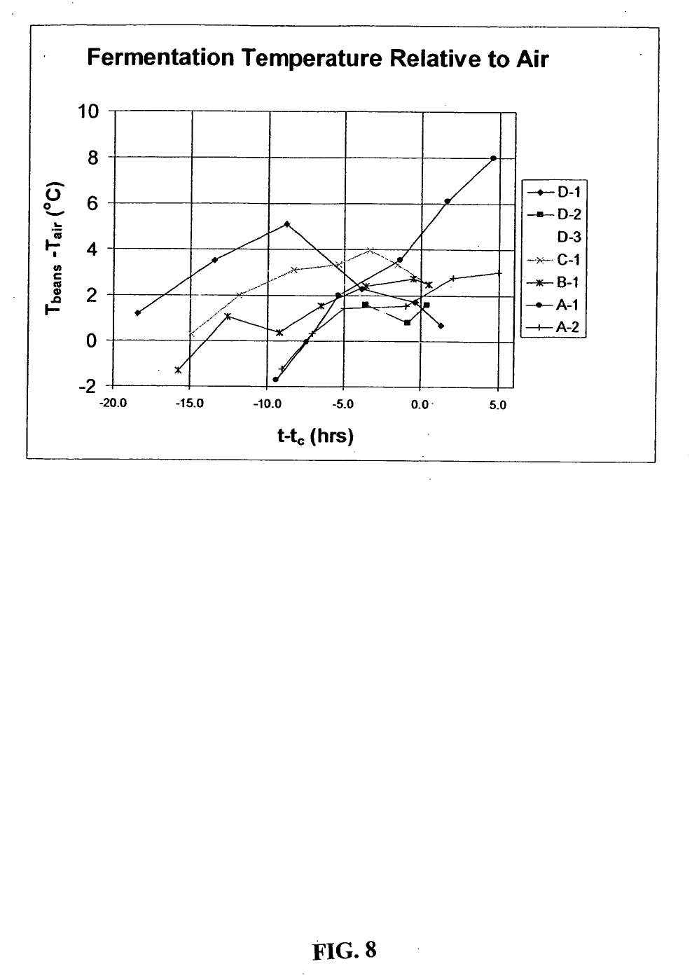

A thermometer is also preferably provided in the kit of the present invention. A variety of temperature measurements may be taken, however, it is preferred that a coffee farmer take the temperature of the fermenting batch of coffee, and optionally, the fermentation temperature relative to the air temperature. FIGS. 7 and 8 show temperature rates of seven different fermenting batches of coffee. FIG. 7 graphs temperatures of fermenting batches of coffee, while FIG. 8 is directed to the air temperature relative to the fermenting batches of coffee.

The temperature of a fermenting batch of coffee assists in the assessment of the completion of the fermentation process, as microorganismic or enzymatic fermentation releases energy and heat is produced during the fermentation process. Rapidly rising fermentation temperatures may, therefore, be an indication of very rapid or “run-away” fermentation.

Typically, and under a wide variety of conditions, the fermentation temperature of a fermenting batch of coffee is maintained within the range 21-23° Celsius prior to completion. The air temperature surrounding a fermenting batch of coffee is likely to vary significantly based on the location of the coffee farm, the time of day and the fermenting batch of coffee. Air temperature may serve as an indication of “run-away” or excessive fermentation.

Understanding that most coffee producers will not want to memorize various optimal pH levels, ethanol measurements, and lactic acid measurements in order to assess the fermentation rate of coffee, it is preferred that the kit include some type of color scale. This color scale preferably corresponds to the various fermentation states, rates and measurements, and provides a coffee producer with the ability to conduct a color comparison of the at least one pH strip, at least one ethanol strip, and at least one lactic acid strip using an optional visual color comparison chart. This allows the coffee producer to conduct a test and assess the test results to a color chart, which corresponds to the various stages of the fermentation process, including under-fermentation, fermentation completion, and over-fermentation.

In an optional embodiment, at least one glucose strip may be included in the kit. Glucose is one of the simple sugars present in coffee mucilage that can be used as a carbon source by the microorganisms active in coffee fermentation. Generally, the concentration of glucose in a fermenting batch of coffee is in the range of 200-600 mg/dL, which decreases as it is consumed by the microorganisms throughout the course of fermentation. Glucose is not necessarily exhausted at the completion of the fermentation process. The level of glucose taken at the beginning of the fermentation process may provide a measurement of the effect of using water during the pulping process. When the coffee is moved from the pulping process to the fermentation process, a glucose reading may provide information necessary to adjust the desirable activity process of the coffee during the fermentation process.

Method

The preferred method of testing and assessing the fermentation rate of coffee is preferably commenced after a plurality of coffee cherries have completed the pulping process and are located in some type of vat or holding tank, optionally along with a liquid, preferably water. The amount of coffee and liquid contained in the vat, vessel or holding tank (collectively, the “vessel), will vary based on the coffee producer, and there should be no limitation implied in this detailed description based on the amount of coffee or liquid located in the vat or holding tank.

In the first step, a sample of coffee including any associated mucilage and liquid is removed from the vessel in which the coffee is fermenting. The amount of coffee removed from the vessel is irrelevant, but in a preferred embodiment, approximately 115 coffee beans are removed from the vessel. The coffee beans are preferably removed approximately 30 centimeters from an edge of the vessel and from approximately 15 cm beneath the surface of the mass of coffee, although it will be understood that the coffee beans may be removed from any location in the vessel for purposes of performing the method of the present invention. The coffee sample is then mixed with a solution of water, preferably purified water, to form a coffee sample. In an exemplary embodiment, the coffee may be mixed with approximately 50 mL of purified water to form the coffee sample.

In the second step, pH tests, ethanol tests, lactic acid tests, and optionally, glucose tests, are conducted within the coffee sample. In a preferred embodiment, these tests are conducted immediately after the completion of the pulping process, and then at three or four hour intervals until the coffee is washed. Although there is no limitation as to the order in which these tests are conducted, in a preferred embodiment, the tests are conducted in the following sequence: pH test, lactic acid test, ethanol test and, optionally, the glucose test.

In conducting the pH, ethanol, lactic acid, and optional glucose tests, the test strip is preferably immersed in the aqueous suspension, and then immediately removed. The excess liquid is removed by shaking the strip. The strip is preferably retained for approximately two minutes while color develops. The strip may then be compared to the analysis chart, which is preferably a color chart, for visual color comparison. Preferably, the color scale provides an outline of the fermentation rate, fermentation byproducts, and information about fermentation completion, based on the individual colors on the color scale. For example, for pH strips, if the pH test strip is in an acidic environment, the indicator will react with the acid and produce a color corresponding to “acidic” on the corresponding color chart.

To conduct a test of the temperature of the fermenting batch of coffee, the thermometer is preferably placed in the mass of fermenting coffee, preferably, at a distance of at least thirty centimeters from the edge of the mass and about fifteen centimeters deep within the mass. Testing the temperature of the air may be conducted in any manner known in the art.

### EXAMPLES

### Example 1

A single batch of coffee cherries, approximately thirty (30) kilograms in weight, was depulped and divided into small fermentation batches that were intentionally stopped at various pH's, washed, dried and then roasted and taste-evaluated by cupping. The experiments were conducted Dec. 15-18, 2004 on the farm La Canavalia in Matagalpa, Nicaragua. The cupping results are from certified tasters at CECOSEMAC, R. L., Central de Cooperativas de Servicios Multiples “Aroma del Café.” The results are gathered in the table below:

Table of cupping totals (out of 100 possible points) for fermentations stopped at time T, T+4 hours, and T+8 hours. The pH in parentheses is the measured pH at the time the coffee batch was washed.

| Batch T | Batch T + 4 hrs | Batch T + 8 hrs |
|---|---|---|
| 89 (pH 4.5) | 73 (pH 3.5) | 80 (pH 3.4) |
| 90 (pH 4.6) | 89 (pH 3.6) | 88 (pH 3.8) |
| Moldy | 75 (pH less than 4) | Less than 60 - astringent |
| | | (pH 3.3) |
| Moldy | Less than 60 - Over | 77 (pH less than 4) |
| | fermented (pH 3.4) | |

The coffee was rated on a scale of 1-10 for fragrance and aroma, acidity, flavor, body, after-taste and balance. The highest rated coffee was in the “excellent” range, corresponding to those two batches stopped at time T and pH 4.5 to 4.6. The cupper's characterization was “an excellent coffee with good characteristics, aroma of flowers and chocolate” in one case and “a coffee with excellent characteristics, good body, acidity and excellent after-taste, sweet and mild” in the other case. The batches that were disqualified as “moldy” had experienced a delay in drying and therefore lost their taste character. The batches stopped at T+4 hrs and pH less than 4 had one with excellent qualities and the other described as “commercial grade coffee without flavor and little body and acidity.” The batches stopped at T+8 hrs and pH less than 4 had less flavor and acidity or were disqualified due to high astringency, or lower ratings in all categories.

These results on a common batch of coffee cherries demonstrate the relationship between pH at which the batch was washed and the subsequent quality of the roasted coffee. If coffee in the excellent range (90-100) is to be obtained, then it is important to stop the fermentation and wash the coffee before the pH drops to 4.0 or below. It is preferred to stop the fermentation at pH 4.5-4.6.

### Example 2

Ten (10) kits containing at least one pH strip and thermometer, were distributed to coffee producers on small coffee farms throughout Matagalpa, Nicaragua on Dec. 15, 2004.

In twenty six separate coffee fermentation batches monitored on nine different farms, the results were consistent. The initial pH of all batches was in the range 5.0 to 5.8. For all batches the pH at the time of initiation of washing was at or below the low end of the scale of pH paper supplied with the kit, 4.0 or less. This indicates that all of the batches were over-fermented by the tentative “standard” of good quality established in the field study and in the development work on the kit described in Example I (above). Thus, the need for a kit to monitor pH is verified. This same group of farmers had independent cupping results on their coffee for the 2004 season in the range 70-80. Therefore it is predicted that the use of the kit in a trained producer's hands will enable them to improve the taste quality of their coffee by about ten points.

When introducing elements of the present invention or the preferred embodiment thereof, the articles “a,” “an,” “the,” and “said” are intended to be inclusive and mean that there are one or more of the elements. The terms “comprising,” “including” and “having” are intended to be inclusive and mean that there may be additional elements other than the listed elements.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A kit for testing the fermentation rate of coffee beans, said kit comprising:
(a) at least one pH test strip;
(b) at least one ethanol test strip;
(c) at least one lactic acid test strip; and
(d) a thermometer.

2. The kit of claim 1, further comprising a vessel for collecting a sample from a plurality of fermenting coffee beans.

3. The kit of claim 1, further comprising a mechanism for transferring a measured amount of the sample to any of the group set forth in (a)-(d) of claim 1.

4. The kit of claim 1, further comprising a color scale for visual color comparison, where the fermentation rate of the coffee beans is determinable from individual colors on the scale.

5. The kit of claim 1, further comprising at least one glucose strip.

6. A method for determining the fermentation rate of coffee beans, comprising the following steps:
(a) mixing a plurality of coffee beans and water to obtain a mixed sample;
(b) transferring a measured amount of the mixed sample to a substrate; and
(c) visually comparing the coloration of the substrate with a color scale, thereby determining a specific fermentation rate of the coffee beans.

7. The method of claim 6, wherein the substrate is chosen from a group consisting of pH test strips, alcohol test strips, and ethanol test strips.

8. The method of claim 6, further comprising reviewing a color scale for visual color comparison, where the fermentation rate of the coffee beans is determinable from individual colors on the scale.

9. Coffee having consistent quality and process therefor, said process including:
(a) mixing a plurality of coffee beans and water to obtain a mixed sample;
(b) transferring a measured amount of the mixed sample to a substrate; and
(c) visually comparing the coloration of the substrate with a color scale, thereby determining the completion of the fermentation of the coffee in a consistent manner.
